(19) United States
(12) Patent Application Publication
(10) Pub. No.: US 2011/0186556 A1
(43) Pub. Date: Aug. 4, 2011

(54) HYBRID AUTOMATED WELDING SYSTEM

(75) Inventors: Carl A. Heinrich, Burnaby (CA); Abdolreza Abdollahi, North Vancouver (CA); Jose Mendoza, Coquitlam (CA); Andreas Boll, New Westminster (CA)

(73) Assignee: ROBOWELD INC., Burnaby, BC (CA)

(21) Appl. No.: 12/866,669

(22) PCT Filed: Feb. 6, 2009
(86) PCT No.: PCT/CA09/00166

§ 371 Date: Sep. 30, 2010

Related U.S. Application Data
(60) Provisional application No. 61/026,707, filed on Feb. 6, 2008.

(51) Int. Cl. B23K 9/00

(52) U.S. Cl. 219/136; 219/137 R

(57) ABSTRACT

A system for welding work pieces together comprises a support assembly configured to permit movement of an end effector assembly throughout a range of operating positions, and an end effector assembly comprising a platform arm pivotally coupled to the support assembly. Radial and longitudinal slide assemblies are coupled between the platform arm and a platform. A rotary actuator is mounted on the platform. A torch arm is coupled to the rotary actuator and extends along an axis of rotation of the rotary actuator. The torch arm has a torch holder at an end thereof configured to hold a welding torch. The rotary actuator can selectively twist the torch arm such that the welding torch undergoes a weaving motion. The system may be operated fully automatically under control of a controller, or in a hybrid mode wherein real time user intervention is permitted to adjust motion and/or operation of the torch.

### REFERENCE TO RELATED APPLICATION

This application claims priority from U.S. patent application No. 61/026,707 filed on 6 Feb. 2008 and entitled HYBRID AUTOMATED WELDING SYSTEM. For purposes of the United States of America, this application claims the benefit of U.S. patent application No. 61/026,707 filed on 6 Feb. 2008 and entitled HYBRID AUTOMATED WELDING SYSTEM under 35 U.S.C. §119, which is hereby incorporated by reference herein.

### TECHNICAL FIELD

The invention relates to welding, and particularly to systems for automating certain aspects of fabrication of process piping or other metallic work pieces.

### BACKGROUND

Process piping is typically constructed by welding a number of pipe sections together in fabrication facilities referred to as “spooling shops”. Such spooling shops are often divided into a number of workstations or “booths.” Each welding booth is typically 15 to 20 feet wide and 30 to 40 feet long, and has a mechanism referred to as a “positioner” which engages the pipe sections and rotates them as the sections are being welded together.

The inventors have determined a need for improved systems for automating certain aspects of welding pipe sections or other work pieces together.

### SUMMARY

One aspect of the invention provides an apparatus for welding work pieces having generally circular cross-sections together as the work pieces are rotated. The apparatus comprises a support assembly comprising an end effector mounting mechanism, and an end effector assembly coupled to the end effector mounting mechanism. The support assembly is configured to permit movement of the end effector mounting mechanism throughout a range of operating positions and to hold the end effector mounting mechanism at a desired operating position. The end effector assembly comprises a platform arm pivotally coupled to the end effector mounting mechanism by a platform joint, a radial slide assembly and a longitudinal slide assembly coupled between the platform arm and a platform, the radial slide assembly operable to adjust a position of the platform along a direction generally parallel to a radius of the work pieces, the longitudinal slide assembly operable to adjust the position of the platform along a direction generally parallel to an axis of rotation of the work pieces, a rotary actuator mounted on the platform, and, a torch arm coupled to the rotary actuator and extending along an axis of rotation of the rotary actuator, the torch arm having a torch holder at an end thereof configured to hold a welding torch, the rotary actuator operable to selectively twist the torch arm such that the welding torch undergoes a weaving motion.

Further aspects of the invention and details of example embodiments are discussed below.

### BRIEF DESCRIPTION OF DRAWINGS

The accompanying drawings illustrate non-limiting example embodiments of the invention.

FIG. 1 is an isometric view of a system according to one embodiment of the invention.

FIG. 2 is a top view of the system of FIG. 1.

FIG. 3 is a side view of the system of FIG. 1.

FIG. 4 is a close up view of the end effector assembly of the system of FIG. 1.

FIG. 5 is a close up view of the end effector assembly of the system of FIG. 1 with the cover removed and the feeler arm attached on the other side of the platform arm.

FIG. 6 shows the end effector assembly of the system of FIG. 1 in isolation.

FIG. 7 shows the end effector assembly of the system of FIG. 1 in isolation with the cover removed.

FIGS. 8A-8C show the end effector assembly of the system of FIG. 1 at different default angles.

FIG. 9 shows the feeler arm of the system of FIG. 1.

FIG. 10 shows the auxiliary support mounting block of the system of FIG. 1.

FIG. 11 is an enlarged view of the operator control pendant of the system of FIG. 1.

FIG. 12 is a flowchart showing an example setup method.

FIG. 13 is a flowchart showing an example homing method.

FIG. 14 is a flowchart showing an example method of creating a welding program.

FIG. 15 is a flowchart showing an example method of selecting a welding mode.

FIG. 16 is a flowchart showing an example method of searching for a welding mode;

FIG. 17 is a flowchart showing an example method of creating a motion program.

FIG. 18 is a flowchart showing an example method of merging a welding program with a motion program.

FIG. 19 is a legend explaining the symbols used in FIGS. 12 to 18.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

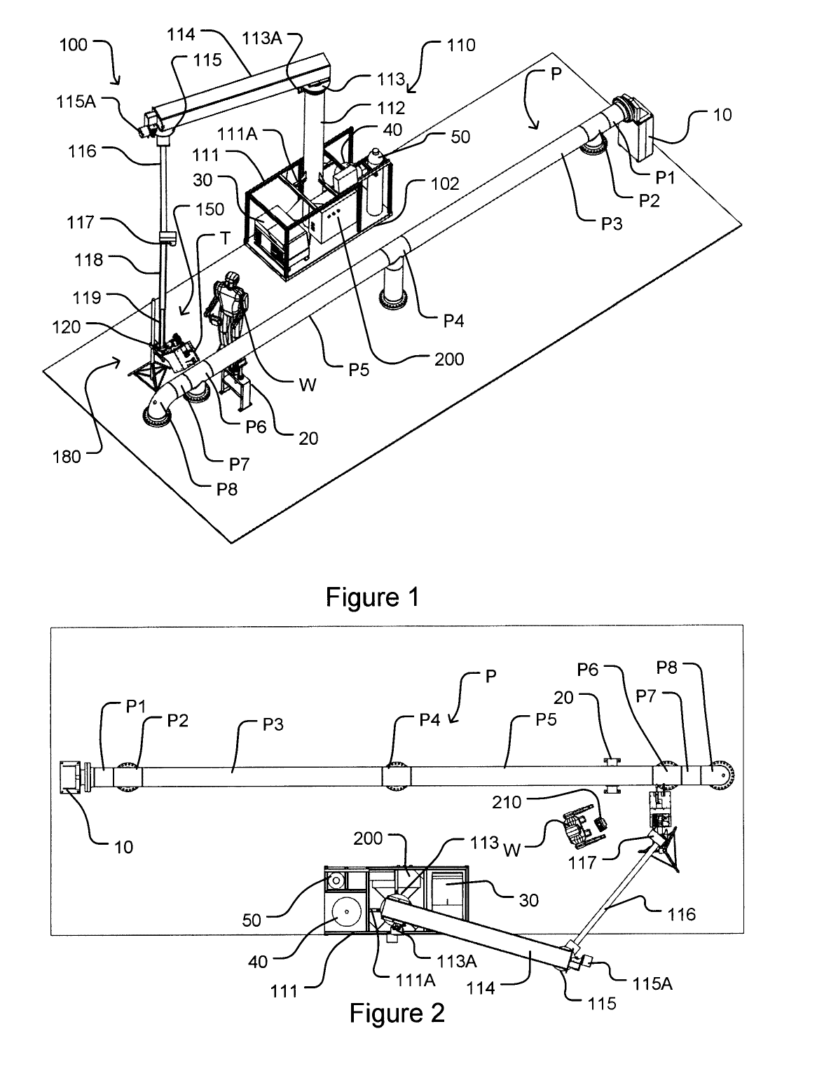

FIGS. 1-3 show a system 100 according to one embodiment of the invention. System 100 is configured for installation in a pipe fabrication facility having a pipe positioner 10 and pipe support 20 for holding a pipe P to be fabricated. Pipe P comprises a plurality of pipe sections P1-8 which are to be welded together. Prior to welding, the pipe sections P1-8 may be held in place by clamps, straps, or the like (not shown). Pipe positioner 10 is configured to rotate pipe P around its longitudinal axis as the pipe sections are welded together. Pipe positioner 10 may be operated by a welder W by means of a foot pedal or other suitable control (not shown) as known in the art. Although the examples discussed herein relate to welding sections of pipe together, it is to be understood that system 100 could also be used for welding other metallic work pieces having a generally circular profile, such as, for example, components of pressure vessels or the like.

System 100 comprises a support assembly 110 which supports an end effector assembly 150. End effector assembly 150 comprises a robotic system having at least three degrees of freedom for manipulating a welding torch T as described below. Support assembly 110 is configured to allow welder W to quickly and easily position end effector assembly 150 at a desired location with respect to pipe P so that torch T may be positioned at an interface between two adjacent pipe sections, as shown in FIGS. 1-3, for example. Support assembly 110 may have a reach of at least 30 feet in some embodiments. System 100 may be dimensioned to fit within a standard welding booth in some embodiments.

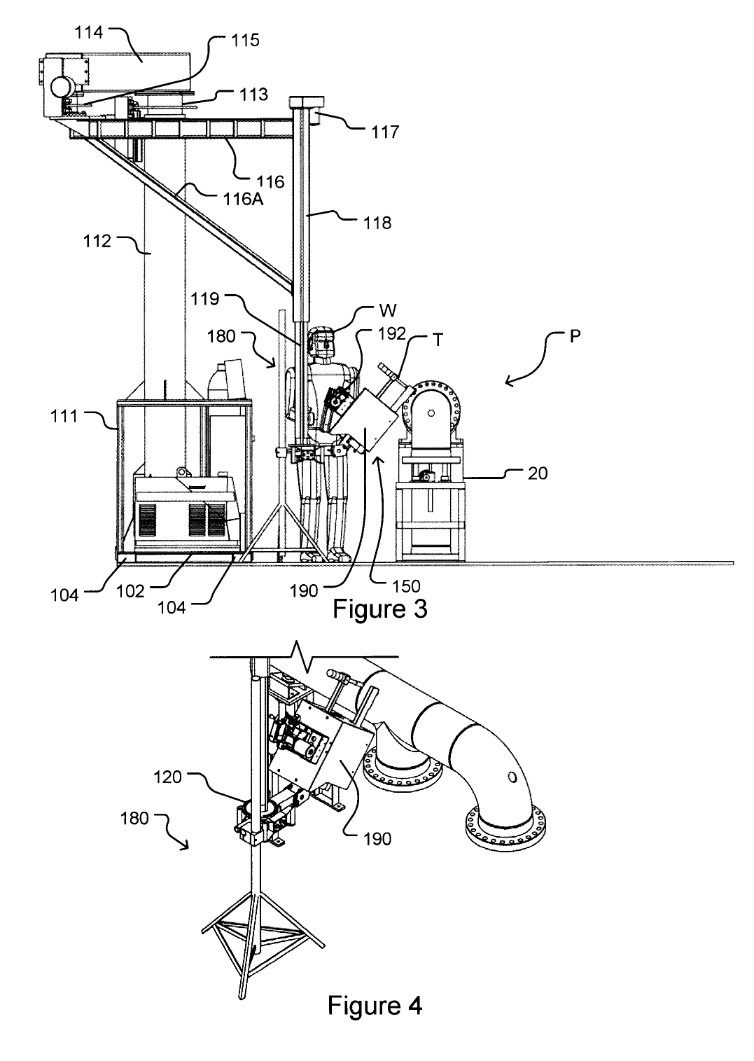

In the illustrated embodiment, support assembly 110 is mounted on a base 102, although it is to be understood that support assembly 110 could be attached directly to the floor of the pipe fabrication facility. Base 102 may also provide space for mounting a power supply 30, a wire supply 40 and a gas supply 50. A controller 200 may also be mounted on base 102, or coupled to support assembly 110. Controller 200 may be configured to control the operation of end effector assembly 150 and torch T, as described below. Base 102 may comprise slots 104 (see FIG. 3) for receiving prongs of a forklift or the like to facilitate transportation and repositioning of system 100.

Support assembly 110 comprises a main mast 112 which extends upwardly from base 102. Support assembly 110 may also comprise a frame 111 extending upwardly around the edges of base 102 to protect the components mounted on base 102. A plurality of braces 111A may extend between frame 111 and main mast 112 to provide added stability to main mast 112. A first boom arm 114 is rotationally coupled to an upper portion of main mast 112 by a first boom joint 113. A second boom arm 116 is rotationally coupled to the outer end of first boom arm 114 (i.e., the end opposite main mast 112) by a second boom joint 115. First and second boom joints 113 and 115 comprise braking mechanisms 113A and 115A, respectively, which prevent movement of joints 113 and 115 unless corresponding release mechanisms are activated, as described below.

A telescoping mast 118 extends downwardly from the end of second boom arm 116 opposite second boom joint 115. A brace 116A may extend diagonally between second boom arm and telescoping mast 118. Telescoping mast 118 comprises a telescopic extension 119. A motor 117 is operatively coupled to telescoping mast 118 for moving telescopic extension 119 up and down, as described below. In some embodiments, telescopic extension 119 provides 50 inches of vertical travel adjustment to allow system 100 to work at varying torch angles on pipes or other work pieces having diameters ranging from 4 to 36 inches.

End effector assembly 150 is rotationally coupled to the lower end of telescopic extension 119 by an end effector joint 120. End effector joint 120 may comprise a locking mechanism (not shown) for selectively locking the orientation of end effector assembly 150 relative to telescopic extension 119.

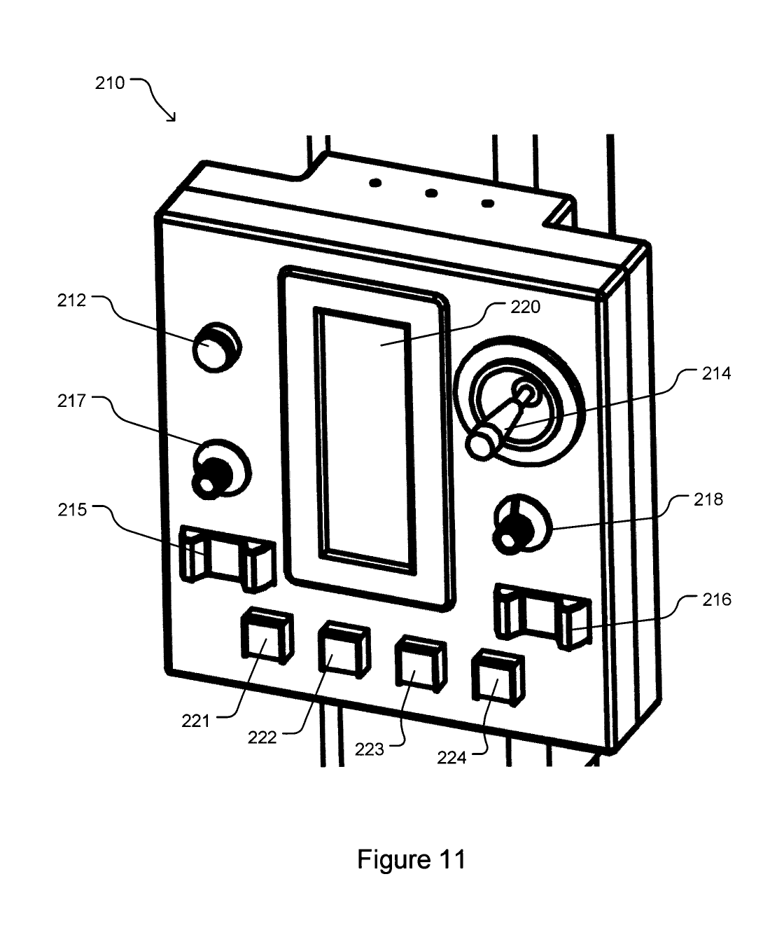

An operator control pendant 210 may be provided for interacting with controller 200. Operator control pendant 210 may be mounted on a suitable location on support assembly 110, such as, for example, on telescoping mast 118, or may be held by welder W, as shown in FIGS. 1-3. Operator control pendant 210 receives user input during operation of system 100 and communicates with controller 200 to provide for on the fly adjustments to the operation of system 100, as described below with reference to FIG. 11. Operator control pendant 210 may be coupled to controller 200 by cables (not shown) or may comprise a wireless communication system (not shown) for communicating with controller 200.

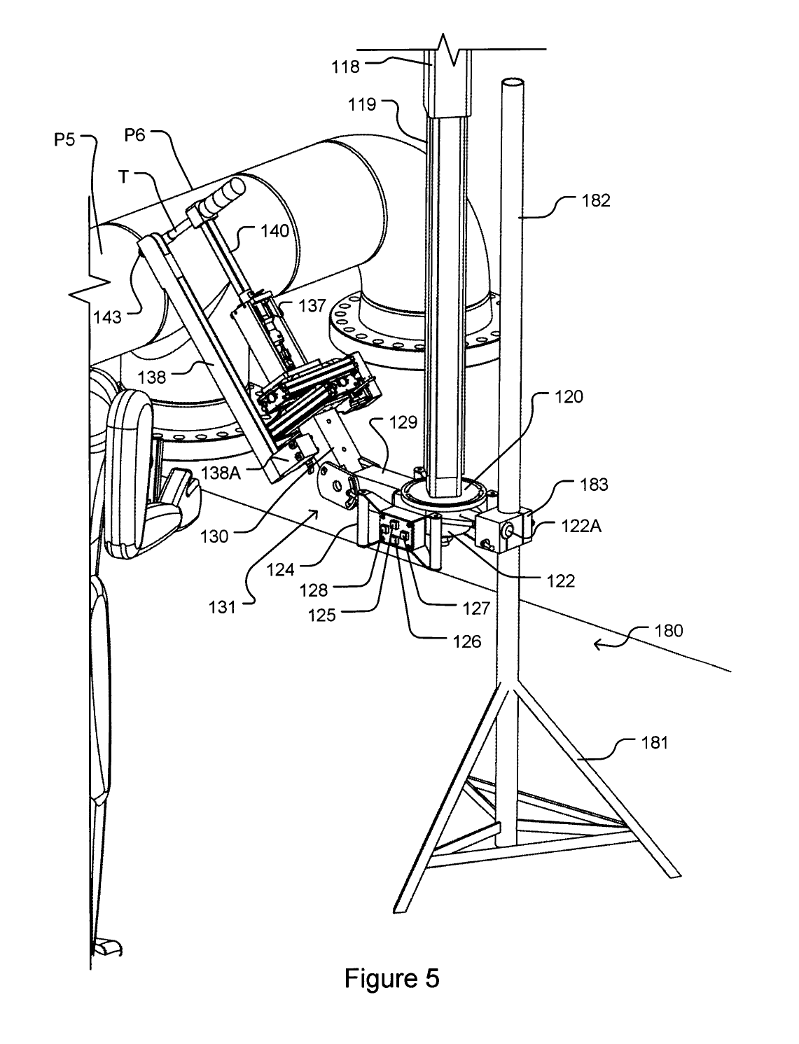

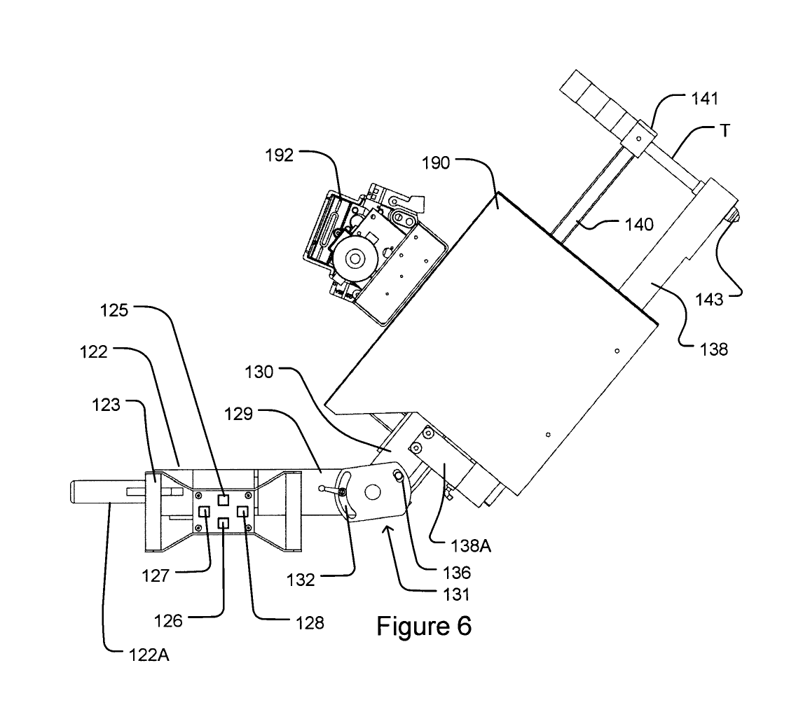

As shown in FIGS. 5 and 6, end effector assembly 150 comprises a mounting block 122 coupled to end effector joint 120. Handle members 123 and 124 are coupled to mounting block 122 for facilitating manual manipulation of end effector assembly 150. Motor control buttons 125 and 126, which may be conveniently located in both handle members 123 and 124, are operatively coupled to motor 117. Boom release buttons 127 and 128, which may also be conveniently located in both handle members 123 and 124, are operatively coupled to the braking mechanisms 113A and 115A of first and second boom joints 113 and 115, respectively. In the illustrated embodiment, all of buttons 125-128 are located in both handle members 123 and 124, in mirror-image positions. However, as one skilled in the art will appreciate, buttons 125-128 may be located in only one of handle members 123 or 124, or any other convenient location. Motor control buttons 125 and 126, when depressed, cause motor 117 to lower and raise telescopic extension 119, respectively. Boom release buttons 127 and 128, when depressed, allow rotational movement of first and second booms 114 and 116 about first and second boom joints 113 and 115, respectively. End effector assembly 150 may thus be rapidly repositioned at a desired operating location by pressing boom release buttons 127 and 128 and manually moving end effector assembly 150 to the operating location, then adjusting the height of end effector using motor control buttons 124 and/or 125. This permits welder W to position end effector assembly 150 and cause system 100 and begin welding within about one minute once the pipe sections or other work pieces are in place.

An auxiliary support 180 may be provided to stabilize end effector assembly 150 during operation. As shown in FIG. 5, auxiliary support 180 comprises a tripod base 181 with a vertical post 182 extending upwardly therefrom. An auxiliary support mounting block 183 is slidably mounted on vertical post 182 and configured to receive a horizontal post 122A extending from mounting block 122. As shown in FIG. 10, auxiliary support mounting block 183 comprises a vertically-oriented aperture 184 for receiving vertical post 182. A slot 185 is defined in auxiliary support mounting block 183 adjacent aperture 184, and a clamping mechanism 186 is provided to selectively compress slot 185 and secure auxiliary support mounting block 183 at a desired height along vertical post 182. Similarly, auxiliary support mounting block 183 comprises a horizontally-oriented aperture 187 for receiving horizontal post 122A. A slot 188 is defined in auxiliary support mounting block 183 adjacent aperture 187, and a clamping mechanism 189 is provided to selectively compress slot 188 and secure horizontal post 122A within aperture 187.

A cover 190 may be coupled to platform arm 130 for covering certain components of end effector assembly 150. A wire feeder 192 may be mounted on cover 190 for supplying wire from wire supply 40 to torch T. Wire and cables extending between torch T and power supply 30, wire supply 40, gas supply 50, and controller 200 for providing torch T with welding capability under control of controller 200, are not shown in the illustrated embodiments to avoid obscuring the drawings.

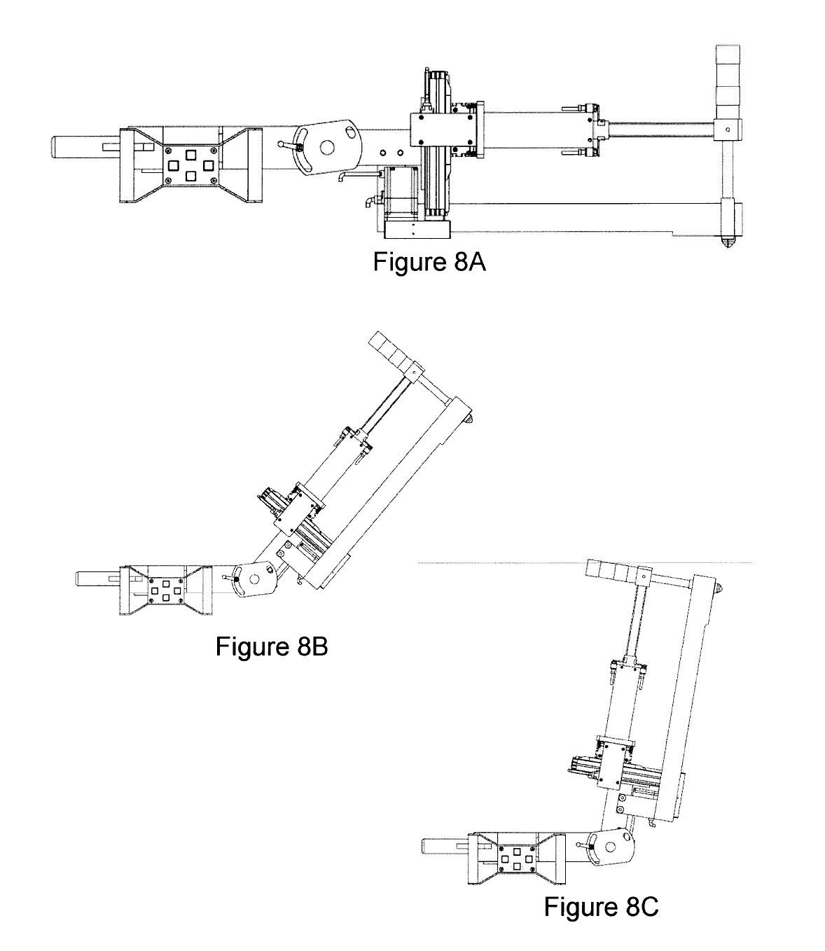

As best seen in FIGS. 5 to 7, a platform boom 129 extends outwardly from mounting block 122. A platform arm 130 is pivotally coupled to the end of platform boom 129 by a platform joint 131. Platform joint 131 comprises an angular adjustment mechanism 132 for selectively setting a default angle of platform arm 130 with respect to platform boom 129 (which is generally horizontal in the illustrated embodiment). Platform arm 130 may be positioned such that it is approximately parallel to a tangent to the circumference of pipe P once welder W has positioned end effector assembly 150 in a desired position near a joint between pipe sections to be welded. The default angle of platform arm 130 with respect to the horizontal is typically selected to be between 0 and 60 degrees, although platform joint 131 may be configured to allow the default angle of platform arm 130 to be anywhere between 0 and 90 degrees in some embodiments. FIGS. 8A-8C show end effector assembly 150 with platform arm 130 at a variety of different default angles. Platform joint 131 also comprises a slot 136 for receiving a floating pin (not shown) extending from platform arm 130, which allows the angle of platform arm 130 to be tilted upwards approximately 10 degrees from the default angle, as described below.

A radial slide assembly 133 and a longitudinal slide assembly 134 are coupled between platform arm 130 and a platform 135. In this context, “radial” refers to a direction generally parallel to the radius of pipe P and “longitudinal” refers to a direction generally parallel to the longitudinal axis of pipe P (which is also the axis about which pipe P is rotated by positioner 10). In the illustrated embodiment, radial slide assembly 133 coupled to platform arm 130 and longitudinal slide assembly 134 is coupled to platform 135, but it is to be understood that the order of slide assemblies 133 and 134 could be reversed, with radial slide assembly 133 coupled to platform 135 and longitudinal slide assembly 134 is coupled to platform arm 130. Radial slide assembly 133 comprises an actuator (not specifically enumerated) for moving longitudinal slide assembly 134 back and forth along the radial direction under the control of controller 200, and one or more encoders (not specifically enumerated) for providing controller 200 with information about the position of radial slide assembly 133. Similarly, longitudinal slide assembly 134 comprises an actuator (not specifically enumerated) for moving platform 135 back and forth along the longitudinal direction under the control of controller 200, and one or more encoders (not specifically enumerated) for providing controller 200 with information about the position of longitudinal slide assembly 134.

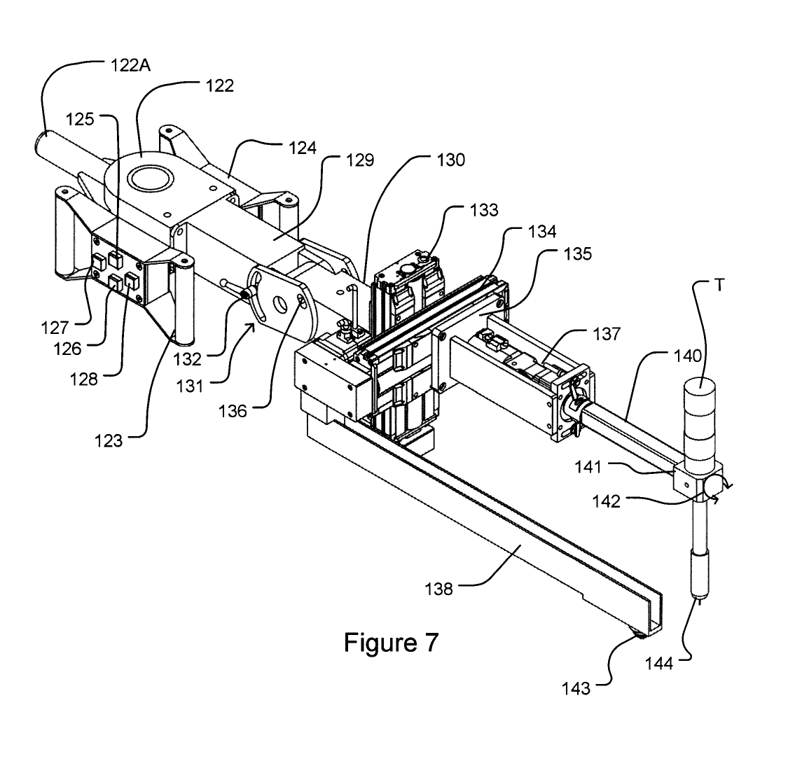

A rotary actuator such as, for example, a servo motor 137 is mounted on platform 135. A torch arm 140 having a torch holder 141 at the end thereof for holding torch T is coupled to servo motor 137. Torch holder 141 may comprise an aperture for receiving torch T and configured such that torch T is oriented generally perpendicularly to torch arm 140. Servo motor 137 is operable to twist torch arm 140 as indicated by double sided arrow 142 (see FIG. 7) under control of controller 200 to accomplish a weaving motion. Servo motor 137 comprises one or more encoders (not specifically enumerated) for providing controller 200 with information about the position of torch arm 140. Radial slide assembly 133, longitudinal slide assembly 134, and servo motor 137 thus provide end effector assembly with three degrees of freedom.

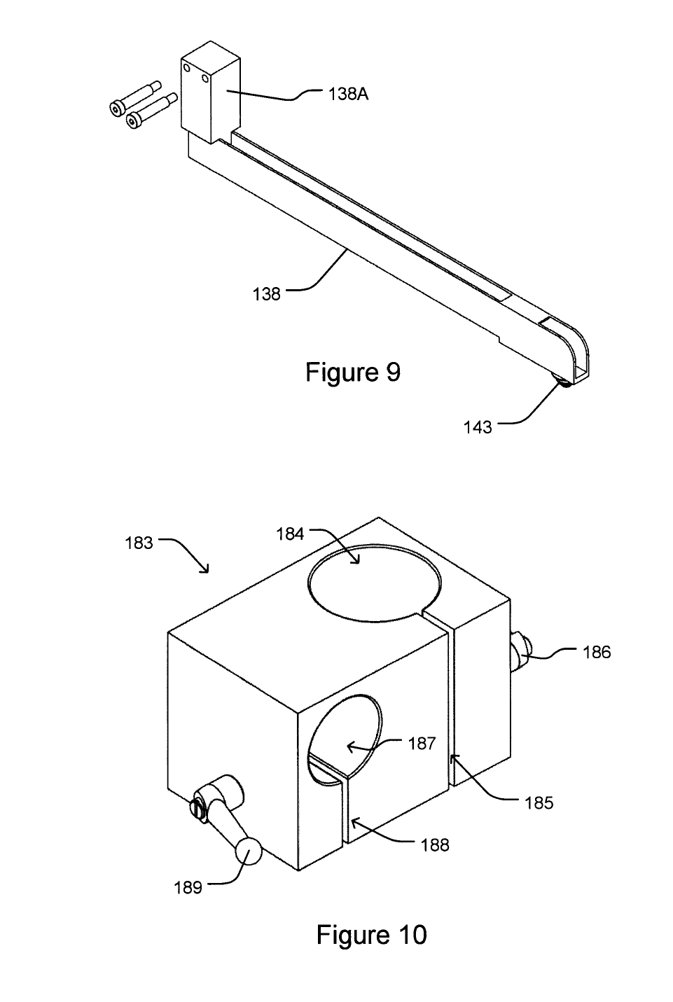

A feeler arm 138 is coupled to platform arm 130 between platform joint 131 and slide assemblies 133 and 134. Feeler arm 138 may, for example, be coupled to platform arm 130 by bolts (not specifically enumerated) extending through a feeler arm mounting block 138A and into platform arm 130. FIG. 9 shows feeler arm 138, feeler arm mounting block 138A and the bolts in isolation. Feeler arm 138 comprises a roller 143 at the end thereof. Feeler arm 138 and platform arm 130 are mechanically linked to maintain feeler arm 138 and torch arm 140 at a fixed angular relationship with respect to one another, so that when roller 143 is in contact with the outer surface of pipe P, an active end 144 of torch T is at a desired radial position with respect to pipe P as determined by radial slide assembly 133.

Feeler arm 138 may be attached on either side of platform arm 130, so that active end 144 of torch T may be positioned at a joint between pipe sections that is located close to a branch or other protrusion extending radially from pipe P by moving feeler arm 138 to the side of platform arm 130 that is opposite the protrusion. For example, as shown in FIG. 4, when torch T is positioned at the interface between pipe sections P5 and P6, feeler arm 138 might interfere with the rotation of pipe section P6 (which comprises a branch extending radially outwardly). To accommodate for the rotation of pipe section P6, cover 190 may be removed and feeler arm 138 may be attached to the opposite side of platform arm 130, as shown in FIG. 5.

The default angle of platform arm 130 may be selected using angular adjustment mechanism 132 such that when roller 143 is in contact with the outer surface of pipe P, the floating pin is located approximately in the middle of slot 136. Such a configuration allows platform arm 130 to freely pivot or “float” approximately 5 degrees up or down. In some embodiments, this floating movement of platform arm 130 corresponds to a range of motion of approximately ±2.5 inches for active end 144 of torch T. Gravity biases roller 143 into contact with pipe P while allowing feeler arm 138 (and thus platform arm 130 and torch arm 140) to pivot away from and toward pipe P, such that active end 144 is maintained in a desired radial welding position (as determined by the position of radial slide assembly 133) as pipe P rotates even when pipe P does not have a completely circular cross-section (i.e., is “out of round”) or if pipe P is not perfectly centered on pipe positioner 10. In some embodiments, platform joint 131 may comprise markings (not shown) to assist welder W in positioning platform arm 130 such that the floating pin is in the middle of slot 136. In other embodiments, platform joint 131 may comprise a sensor (not shown) for providing feedback regarding the position the floating pin in slot 136.

Controller 200 may be programmed with a variety of motion programs for controlling the movements of radial and longitudinal slide assemblies 133 and 134 and servo motor 137. For example, controller 200 may control the radial and longitudinal positions of torch T by operating radial and longitudinal slide assemblies 133 and 134. Controller 200 may control weaving (i.e., oscillation) parameters of torch T by operating servo motor 137. For example, controller 200 may control weaving parameters including frequency, amplitude and left and right dwell times. Controller 200 may also be programmed with a variety of welding programs for controlling the operation of torch T. For example, controller 200 may control welding parameters including wire feed speed, TRIM/Voltage and Wave Control (power source output characteristics). In some embodiments, controller 200 may also be configured to interface with pipe positioner 10 to permit full automatic operation of system 100.

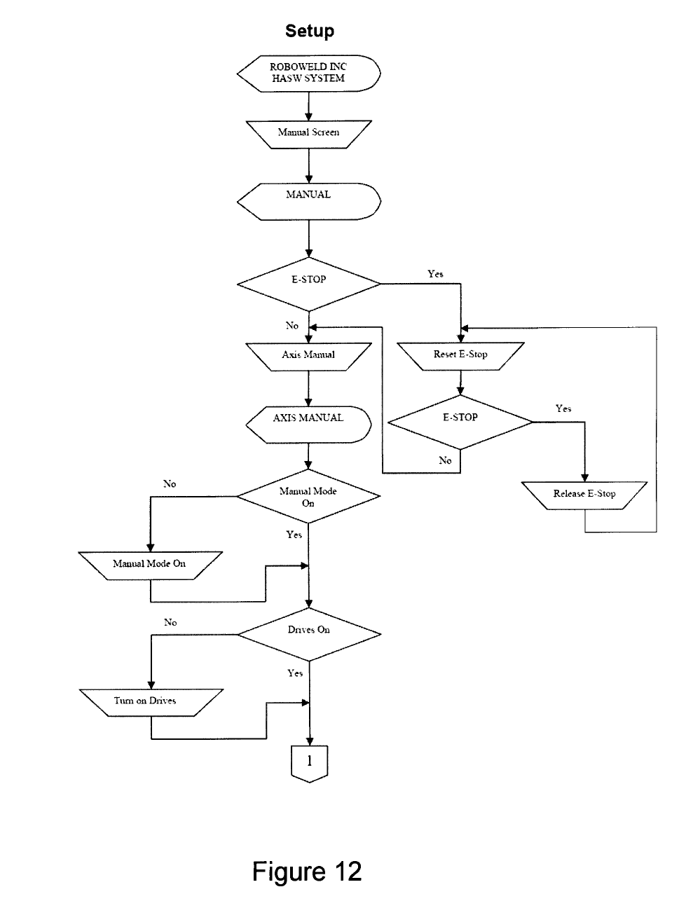

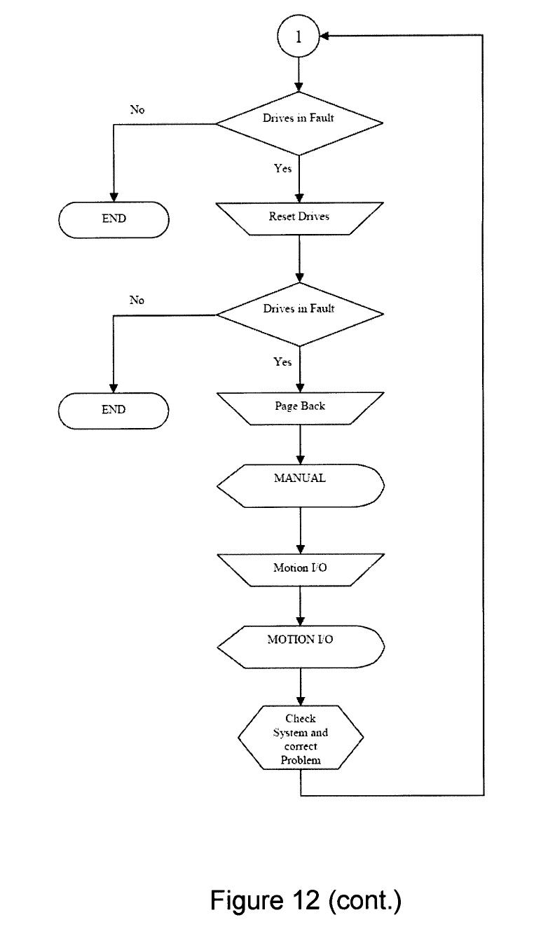

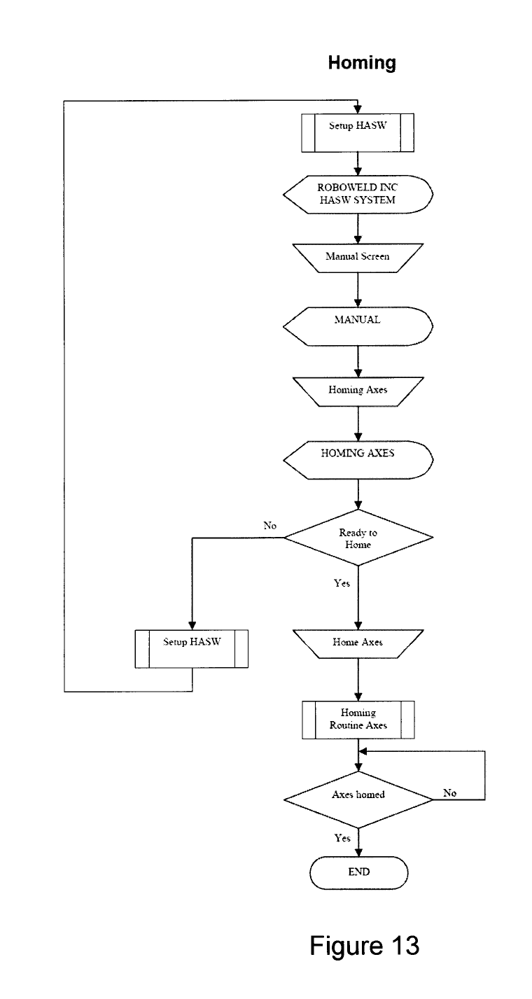

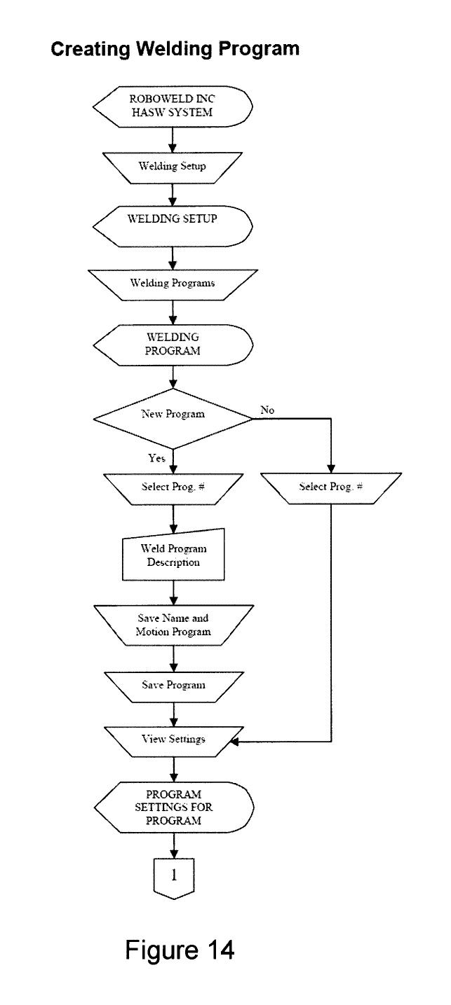

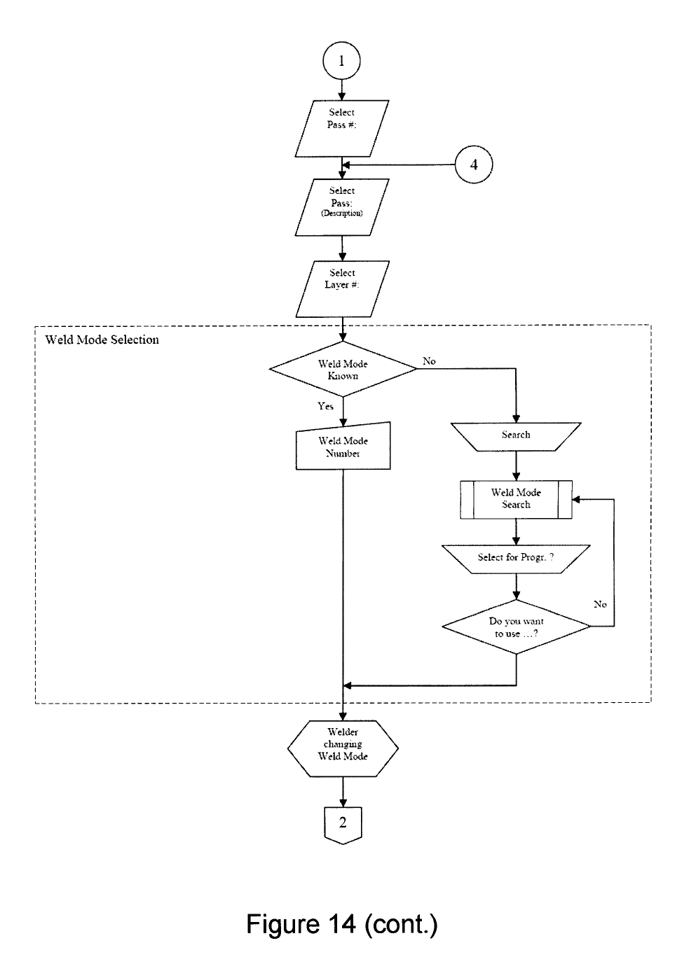

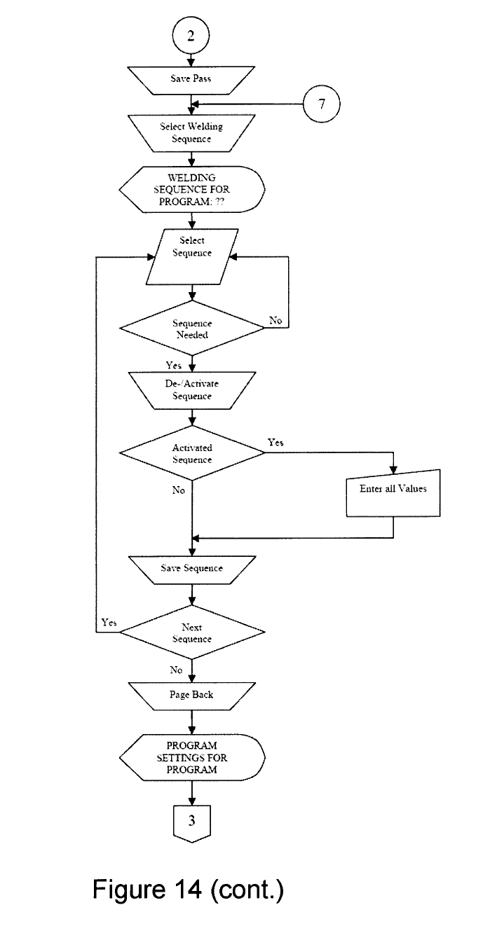

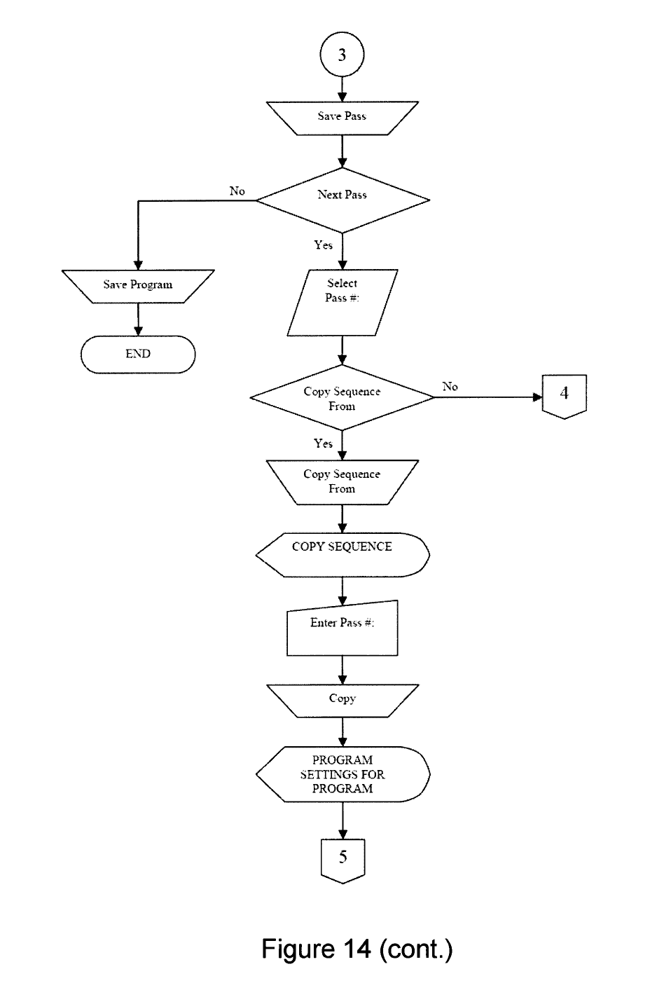

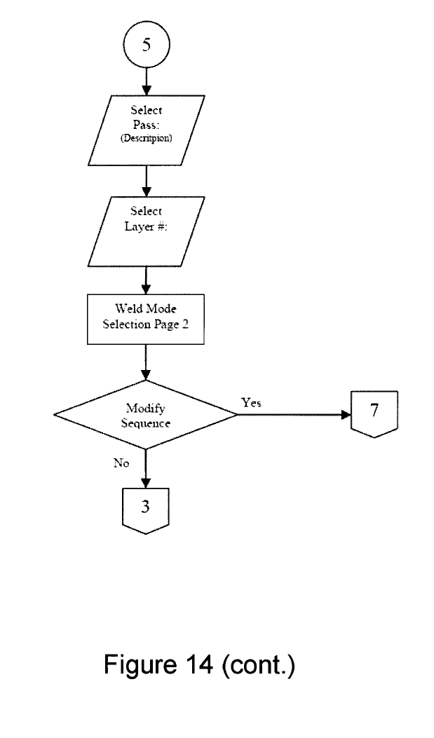

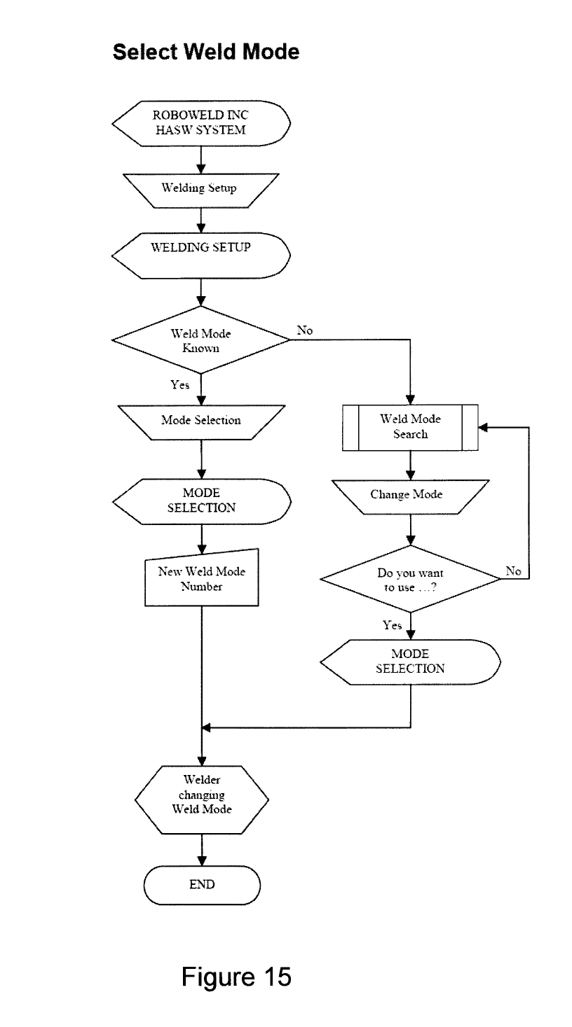

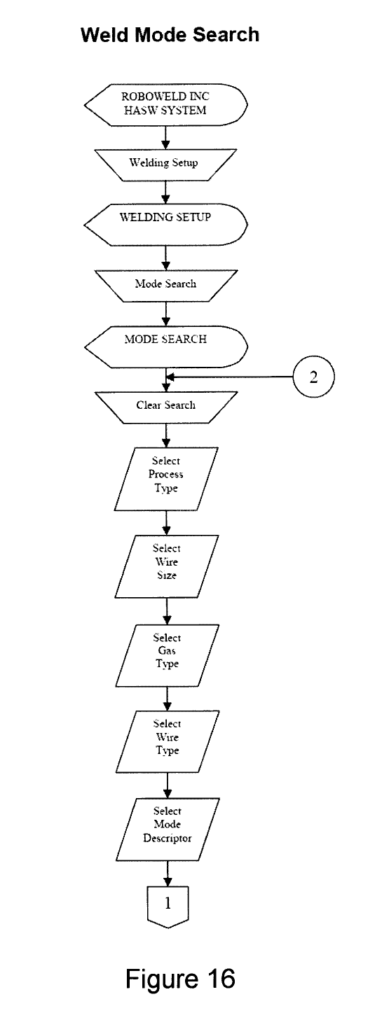

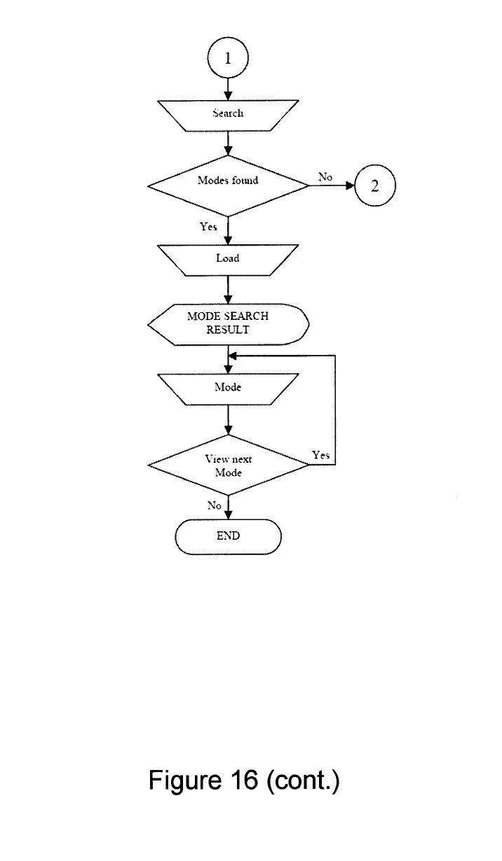

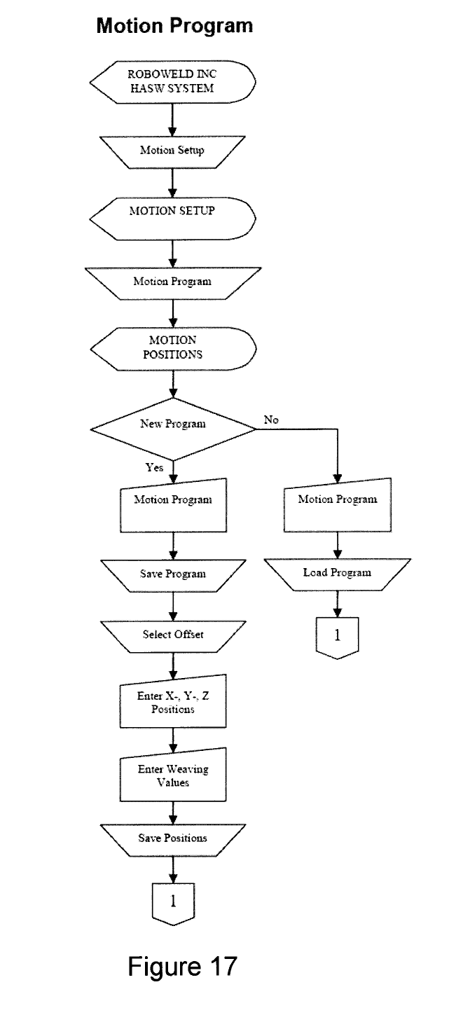

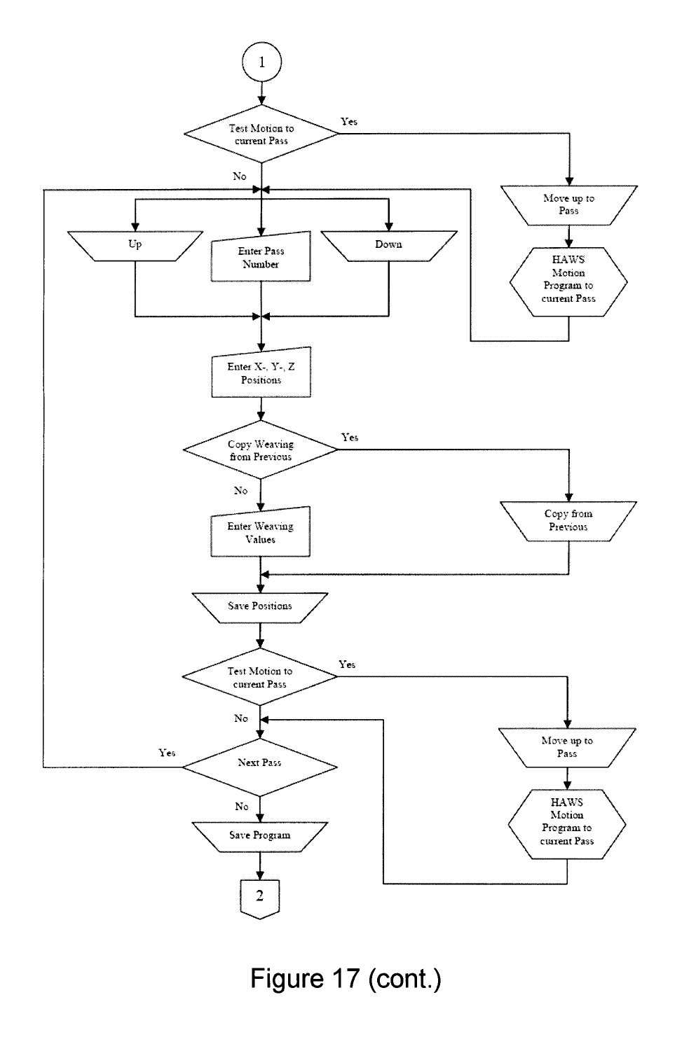

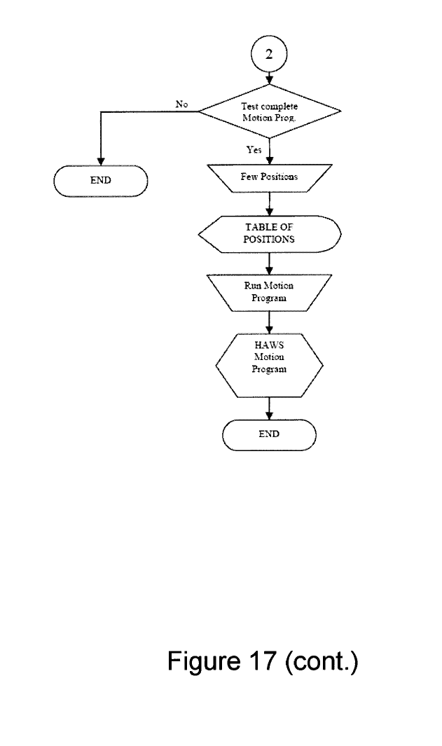

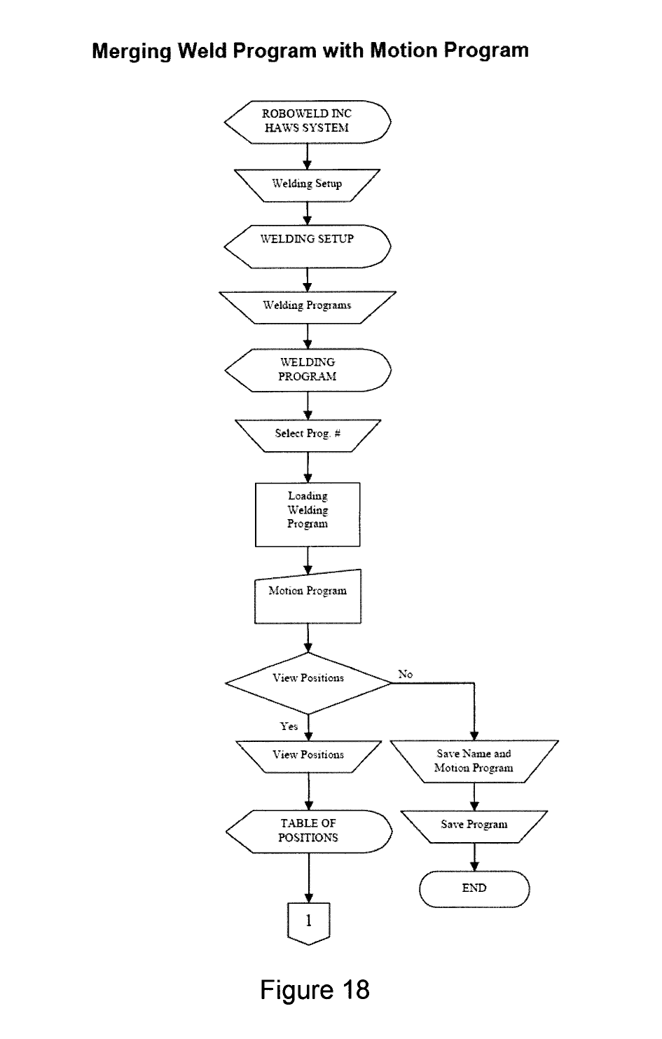

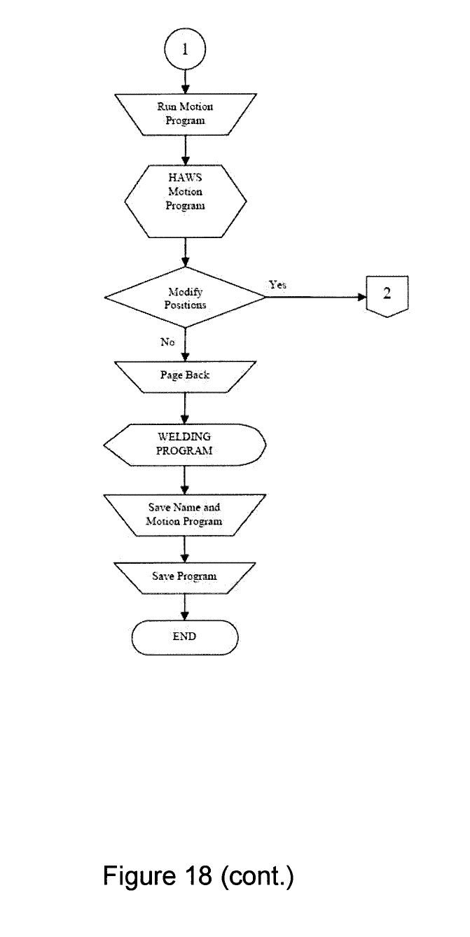

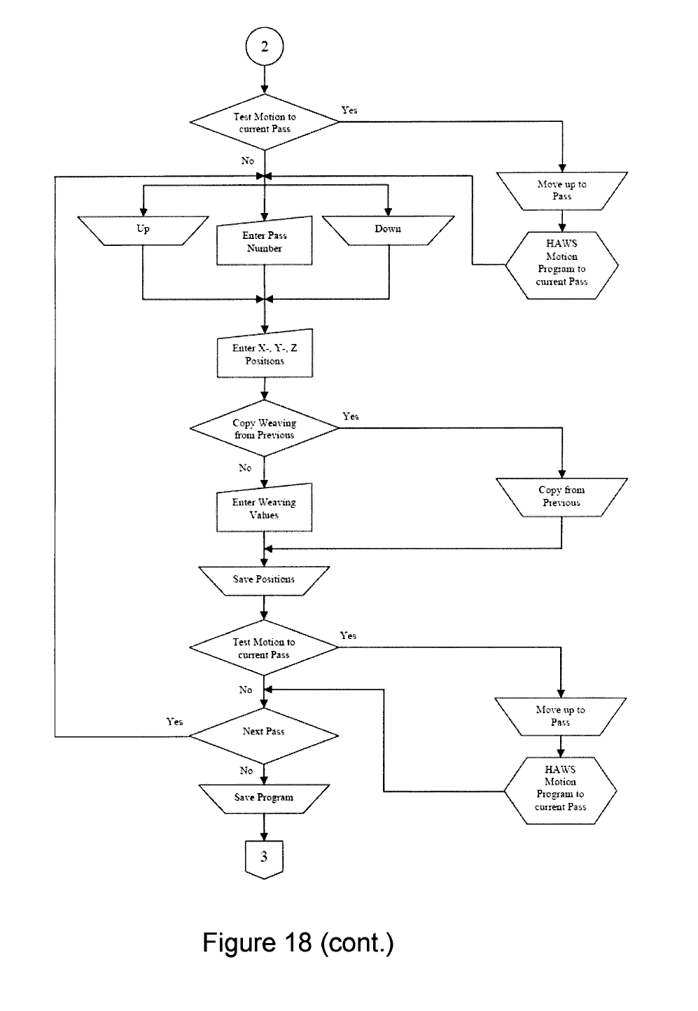

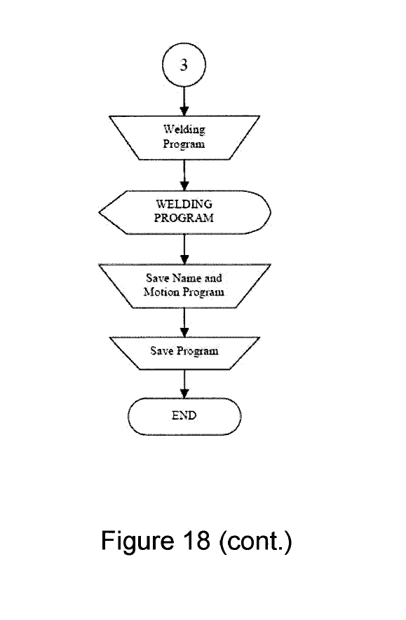

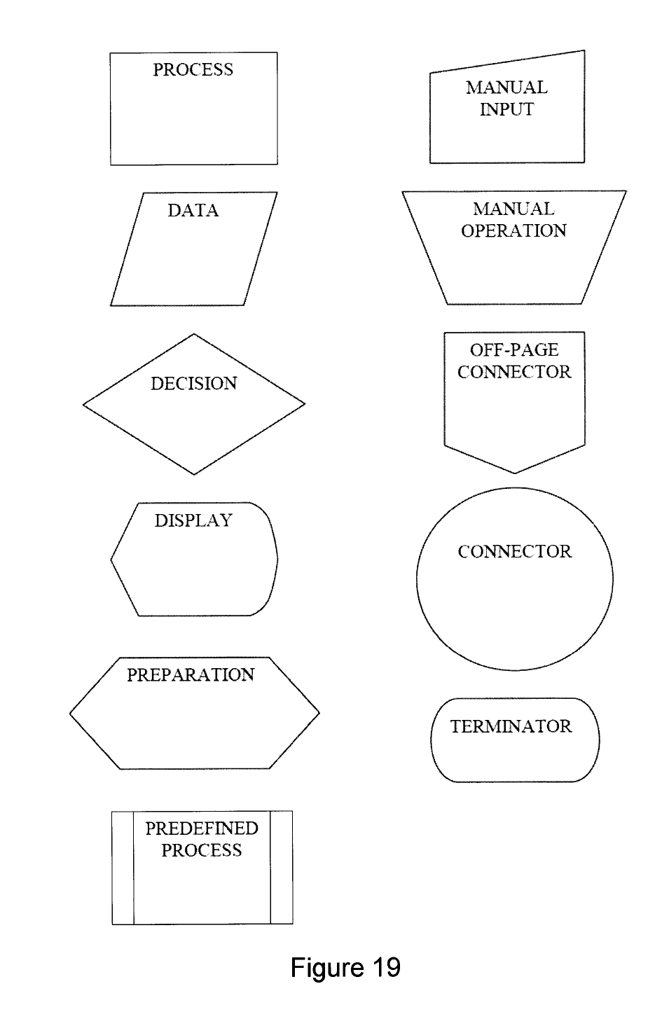

Controller 200 may be provided with a suitable user interface for setting up system 100 and programming movements of end effector assembly 150 and operation of torch T. The flowcharts shown in FIGS. 12-18 illustrate some example steps of methods by which controller 200 may be used to set up and control system 100. FIG. 19 is a legend explaining the meaning of the various symbols used in FIGS. 12-18. System 100 may thus be programmed to operate in a fully automatic mode, wherein no user intervention is required to control the motion of end effector assembly 150 or the operation of torch T once end effector assembly has been moved into a desired operating position.

System 100 may also be operated in a “hybrid” mode, wherein welder W can adjust the programmed motion of end effector assembly 150 and/or operation of torch T during operation to accommodate for irregularities in the pipe sections or other work pieces, or otherwise adjust the welding to be performed. For example, controller 200 may be configured to receive real time user input from operator control pendant 210 to permit on the fly modifications to the motion of end effector assembly 150 and the operation of torch T. As shown in FIG. 11, pendant 210 comprises an emergency stop button 212 for quickly turning off torch T and stopping any motion of end effector assembly 150 in the event of a problem. Pendant 210 also comprises a joystick 214 for controlling the movements of radial and longitudinal slide assemblies 133 and 134.

Pendant 210 may also be provided with rocker switches 215 and 216 and corresponding selector switches 217 and 218. Rocker switches 215 and 216 may be used to control a variety of weaving and welding parameters. For example, rocker switch 215 may control weaving parameters and rocker switch 216 may control welding parameters in some embodiments. The specific parameter controlled by rocker switches 215 and 216 may be selected using selector switches 217 and 218. A display 220 may be provided to indicate which parameters rocker switches 215 and 216 are operable to control at any given time. A plurality of push button switches 221-224 may be provided to permit additional parameters to be controlled using pendant 210. By permitting human intervention through the use of pendant 210, the use of system 100 for “one off” or irregular pipe welding jobs is facilitated without requiring the setting up of dedicated motion and welding programs, or by employing existing motion and/or welding programs with real time modifications by welder W.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. An apparatus for welding work pieces having generally circular cross-sections together as the work pieces are rotated, the apparatus comprising:
a support assembly comprising an end effector mounting mechanism, the support assembly configured to permit movement of the end effector mounting mechanism throughout a range of operating positions and to selectively hold the end effector mounting mechanism at a desired operating position; and,
an end effector assembly coupled to the end effector mounting mechanism, the end effector assembly comprising:
a platform arm pivotally coupled to the end effector mounting mechanism by a platform joint;
a radial slide assembly and a longitudinal slide assembly coupled between the platform arm and a platform, the radial slide assembly operable to adjust a position of the platform along a direction generally parallel to a radius of the work pieces, the longitudinal slide assembly operable to adjust the position of the platform along a direction generally parallel to an axis of rotation of the work pieces;
a rotary actuator mounted on the platform; and,
a torch arm coupled to the rotary actuator and extending along an axis of rotation of the rotary actuator, the torch arm having a torch holder at an end thereof configured to hold a welding torch, the rotary actuator operable to selectively twist the torch arm such that the welding torch undergoes a weaving motion.

2. An apparatus according to claim 1 wherein the platform joint comprises an angular adjustment mechanism configured to selectively set a default angle of the platform arm.

3. An apparatus according to claim 2 wherein the platform joint comprises a slot for receiving a pin extending laterally from the platform arm, such that the platform arm is free to pivot upwards approximately ten degrees from the default angle.

4. An apparatus according to claim 1 comprising a feeler arm coupled to the platform arm between the platform joint and the radial and longitudinal slide assemblies, the feeler arm having a roller at an end thereof and configured such that when the roller is in contact with an outer surface of one of the work pieces, an active end of the welding torch is maintained at a desired radial position with respect to the work pieces.

5. An apparatus according to claim 1 wherein the support assembly comprises:
a main mast extending upwardly from a base;
a first boom arm pivotally coupled at a first end thereof to the main mast by a first boom joint;
a second boom arm pivotally coupled at a first end thereof to a second end of the first boom arm by a second boom joint; and,
a telescoping mast extending downwardly from a second end of the second boom arm, the telescoping mast comprising a telescoping mast comprising a telescoping extension operatively coupled to a motor for adjusting the height of a lower end of the telescoping extension,
wherein the end effector mounting mechanism comprises an end effector joint located at the lower end of the telescoping extension.

6. An apparatus according to claim 5 wherein the end effector assembly comprises a mounting block pivotally connected to the end effector joint such that the mounting block is rotatable about a generally vertical axis.

7. An apparatus according to claim 6 wherein the end effector joint comprises a locking mechanism for selectively locking the orientation of the end effector assembly relative to the telescopic extension.

8. An apparatus according to claim 6 wherein the mounting block comprises at least one handle to facilitate manual manipulation of the end effector assembly.

9. An apparatus according to claim 5 comprising wherein the first and second boom joints comprise first and second braking mechanisms configured to selectively prevent movement of the first and second boom joints, and wherein the end effector assembly comprises first and second boom release buttons operatively connected to the first and second boom joints, respectively, which permit movement of the first and second boom joints when depressed.

10. An apparatus according to claim 5 wherein the end effector assembly comprises first and second motor control buttons operatively connected to the motor to respectively raise and lower the telescopic extension.

11. An apparatus according to claim 1 wherein the support assembly has a reach of at least thirty feet.

12. An apparatus according to claim 1 wherein the apparatus is dimensioned to fit within a standard welding booth.

13. A system for welding work pieces having generally circular cross-sections together as the work pieces are rotated, the system comprising:
an apparatus according to claim 1; and,
a controller operatively connected to the end effector assembly to control operation of the radial and longitudinal slide assemblies and the rotary actuator, the controller comprising a processor and a memory having one or more motion programs stored therein.

14. A system according to claim 13 wherein the memory of the controller has one or more welding programs stored thereon.

15. A system according to claim 14 wherein the controller is configured to fully automate the motion of the end effector assembly and the operation of the welding torch.

16. A system according to claim 15 wherein the controller is configured to accept on the fly modifications to the motion of the end effector assembly and the operation of the welding torch from a user to permit hybrid operation of the system.

17. A system according to claim 13 comprising an operator control pendant operatively connected to the controller, the operator control pendant comprising a user interface configured to control operation of the radial and longitudinal slide assemblies and the rotary actuator, and to adjust welding parameters of the welding torch, wherein the controller is configured to accept real time user input from the operator control pendant.

18. A method welding work pieces having generally circular cross-sections together, the method comprising:
coupling the work pieces to a positioner operable to rotate the work pieces about an axis;
providing a robotic system comprising:
an end effector assembly having at least three degrees of freedom and operable to manipulate a welding torch, the end effector assembly connected to a support assembly configured to permit movement of the end effector assembly throughout a range of operating positions and to selectively lock a position of the end effector assembly; and,
a controller operatively connected to the end effector assembly and the welding torch, the controller configured to control movements of the end effector assembly and operation of the welding torch;
moving the end effector assembly to a desired operating position adjacent to an interface between the work pieces;
rotating the work pieces; and,
causing the controller to execute a motion program and a welding program to weld the work pieces together as they are rotated.

19. A method according to claim 18 comprising receiving real time user input at the controller to adjust movements of the end effector assembly and operation of the welding torch.
